(19) United States
(12) Patent Application Publication
(10) Pub. No.: US 2007/0097422 A1
(43) Pub. Date: May 3, 2007

(54) Information storage medium in which digital contents are recorded, and method and system of managing digital contents

(75) Inventor: Jung-hyeob Lee, (US)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/505,475

(22) Filed: Aug. 17, 2006

(30) Foreign Application Priority Data
Nov. 1, 2005 (KR) 2005-103786

(51) Int. Cl. G06F 3/12

(52) U.S. Cl. 358/1.15

(57) ABSTRACT

An information storage medium in which digital contents having a configuration that are to be reproduced only by a user having authorization, and a method and a system of producing and reproducing the digital contents. In the information storing medium in which digital contents are recorded, the digital contents include device information to identify a user device and digital data, the device information being used to determine a state of a usage authorization of the digital contents.

### CROSS-REFERENCE TO RELATED PATENT APPLICATION

This application claims the benefit of Korean Patent Application No. 2005-103786, filed Nov. 1, 2005, in the Korean Intellectual Property Office, the disclosure of which is incorporated herein in its entirety by reference.

### BACKGROUND OF THE INVENTION

1. Field of the Invention

Aspects of the present invention relate to a method of preventing unauthorized use of digital contents, and, more particularly, to an information storage medium in which digital contents are configured such that they may be reproduced only by a user having authorization to do so, and a method and a system of producing and reproducing the digital contents.

2. Description of the Related Art

Recently, portable devices such as MPEG Audio Layer III (MP3) players, portable multimedia players (PMPs), digital camcorders, and digital cameras, have become widely used. Meanwhile, the use of digital contents including music and moving picture files has rapidly grown as well. As such, digital contents may be freely copied and moved using the Internet or digital devices. In detail, the digital contents may be freely used by an anonymous user via the Internet and easily transmitted to another person. However, often the digital contents are misused and copied by anonymous users in contrast to the intentions of an author of the digital contents. Accordingly, demand, within the digital contents industry and others, for content securement technology to prevent the illegal usage of digital contents is urgently required.

### SUMMARY OF THE INVENTION

Aspects of the present invention provide an information storage medium in which digital contents are recorded, and a method and system of producing, downloading, providing, and reproducing digital contents, so as to fundamentally block unauthorized usage of the digital contents.

The present invention also provides a method and a system to manage digital contents, in which identity information of a user device to reproduce the digital contents is recorded, the digital contents being reproduced in the user device only when a user of the user device is authorized.

According to an aspect of the present invention, there is provided an information storing medium in which digital contents are recorded, wherein the digital contents comprise device information to identify a user device and digital data, the device information being used to determine a state of a usage authorization of the digital contents.

The user device may be a device to reproduce the digital contents.

According to another aspect of the present invention, there is provided an information storing medium in which digital contents are recorded, the information storing medium comprising: a data area in which audio and/or video data is stored; a header area in which header information about the audio and/or video data is stored; and an added information area in which additional information about the audio and/or video data is stored, wherein device information to identify a user device is recorded in at least one of the data area, the header area, and the added information area, the device information being used to determine a state of a usage authorization of the digital contents.

According to another aspect of the present invention, there is provided a method of producing digital contents, the method comprising: obtaining digital data; and inserting device information to identify a user device into the digital data to produce the digital contents.

The obtaining of the digital data may comprise: receiving an audio and/or video signal from an audio and/or video signal source; and encoding the audio and/or video signal in a predetermined format to transform the audio and/or video signal into the digital data.

The encoding of the audio and/or video signal into the digital data may further comprise producing digital data including a data area in which audio and/or video data is stored, a header area in which header information about the audio and/or video data is stored, and an added information area in which additional information about the audio and/or video data is stored, wherein the inserting of the device information may comprise inserting the device information into at least one of the data area, the header area, and the added information area.

The inserting of the device information may comprise: extracting identity information of a device for reproducing the digital data; and inserting the extracted identity information into the digital data.

The inserting of the device information may comprise: decoding the obtained digital data; and encoding the decoded data in a predetermined format and inserting the device information.

The obtaining of the digital data may comprise downloading the digital data from a remote server.

According to another aspect of the present invention, there is provided a method of producing digital contents, the method comprising: receiving an audio and/or video signal from an audio and/or video signal source; extracting device information to identify a user device; and encoding the audio and/or video signal in a predetermined format and inserting the device information.

According to another aspect of the present invention, there is provided a method of providing digital contents, the method comprising: receiving device information to identify a user device; inserting the received device information into digital contents to be provided; and transmitting the digital contents in which the device information is inserted.

According to another aspect of the present invention, there is provided a method of reproducing digital contents, the method comprising: reading device information included in the digital contents, reading device information from a user device reproducing the digital contents, comparing the device information of the digital contents with the device information of the user device, and determining whether the digital contents are to be reproduced according to the comparison result.

The determining of whether or not the digital contents are to be reproduced may comprise determining to reproduce the digital contents if it is determined that the device information of the digital contents is identical to the device information of the user device.

According to another aspect of the present invention, there is provided a server providing digital contents, the server comprising: a digital contents storing unit to store the digital contents; a data transceiver to receive a digital contents request comprising device information to identify a user device and to transmit the requested digital contents to a client requesting the digital contents; and a digital contents transforming unit to obtain the requested digital contents from the digital contents storing unit, to insert the transmitted device information into the obtained digital contents to produce digital contents to be transmitted to the client, and to output the digital contents to the data transceiver.

According to another aspect of the present invention, there is provided a system for reproducing digital contents, the system comprising: a digital contents storing unit to store the digital contents; and a digital contents reproducing unit to obtain the digital contents to be reproduced from the digital contents storing unit, to compare device information inserted in the obtained digital contents with its own device information, and to determine whether the obtained digital contents are to be reproduced.

The system may further comprise: a data transceiver to receive the digital contents via a network; and a digital contents transforming unit to insert its own device information into the received digital contents and storing the digital contents in the digital contents storing unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates a digital contents file format in which device information is recorded, according to an embodiment of the present invention;

FIG. 1B illustrates a digital contents file format in which device information is recorded, according to another embodiment of the present invention;

FIG. 1C illustrates a digital contents file format in which device information is recorded, according to another embodiment of the present invention;

FIG. 2 illustrates an information flow structure among a portable device, a network device, and a contents providing server according to an embodiment of the present invention;

FIG. 3 is a flowchart illustrating a method of producing digital contents according to an embodiment of the present invention;

FIG. 4 is a flowchart illustrating a method of downloading digital contents according to an embodiment of the present invention;

FIG. 5 is a flowchart illustrating a method of providing digital contents according to an embodiment of the present invention;

FIG. 6 is a flowchart illustrating a method of reproducing digital contents according to an embodiment of the present invention;

FIG. 7 illustrates a structure of a digital contents providing server according to an embodiment of the present invention; and

FIG. 8 illustrates a structure of a system for reproducing digital contents according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

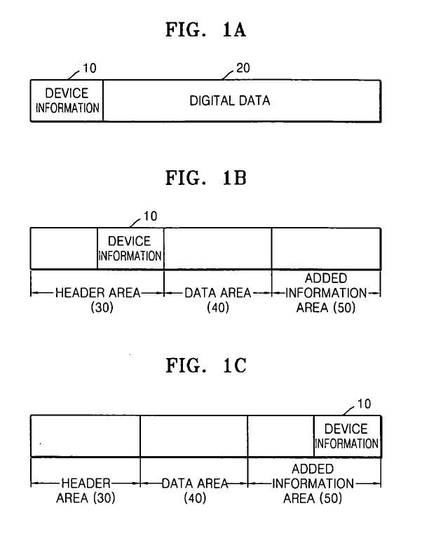

FIG. 1A illustrates a digital contents file format in which device information is recorded, according to an embodiment of the present invention. Referring to FIG. 1A, a digital contents file comprises device information 10 and digital data 20. The device information 10 is identity information to identify a user device to reproduce digital contents. The device information 10 may be a serial number or a model name of a device or other similar data that identifies the user device. The device information 10 is used to determine whether the user device is authorized to reproduce the digital contents when the digital contents are reproduced. The digital data 20 is an area in which data to be protected is recorded.

FIG. 1B illustrates a digital contents file format in which device information is recorded, according to another embodiment of the present invention. Generally, a digital multimedia contents file, such as an MP3 file, comprises a data area 40, in which audio and/or video data is stored, a header area 30 in which header information about audio and/or video data is stored, and an added information area 50, in which additional information about audio and/or video data is stored. Various information about a corresponding file including the format or the size of a file is recorded in the header area 30. The additional information including a title, an artist, a manufacturer, creation day and time of the contents stored in the data area 40 is recorded in the added information area 50. As shown in FIG. 1B, device information 10 to identify the user device is recorded in the header area 30.

FIG. 1C illustrates a digital contents file format in which device information is recorded, according to another embodiment of the present invention. As in FIG. 1B, a digital contents file comprises a header area 30, a data area 40, and an added information area 50. Here, however, device information 10 about the user device is recorded in the added information area 50.

According to the embodiments of the present invention described above, the device information 10 is inserted into the header area 30 or the added information area 50. However, it is noted that the location of the device information 10 is not restricted to the locations discussed above. In fact, the device information 10 may be inserted in any location defined in advance. When a reproducing device reproduces the digital contents recorded in the above-described information storage medium, the reproducing device compares device information thereof with device information recorded in the digital contents and reproduces the digital contents where the device information is found to be substantially identical.

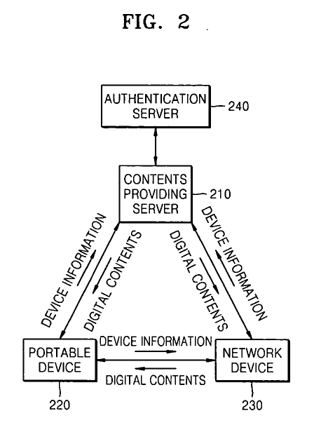

FIG. 2 illustrates an information flow structure among a portable device 220, a network device 230, and a contents providing server 210, according to an embodiment of the present invention. The portable device 220 may comprise devices, such as an MPEG Audio Layer-3 (MP3) player or a portable media player (PMP), that are capable of reproducing digital contents. The network device 230 is a device, such as a personal computer (PC) or a personal digital assistant (PDA), that is equipped with a network function. The contents providing server 210 is a system providing the digital contents to the portable device 220 or the network device 230. Moreover, an authentication server 240 to process the authentication of a device to be provided when the contents are provided may be additionally connected. This authentication processing may be performed in the contents providing server 210 with the contents providing function.

In the portable device 220, when requesting the digital contents from the contents providing server 210 and if device information, which is identity information about the portable device 220, is transmitted, the server 210 inserts the device information, requested by the portable device, into the digital contents and produces and transmits new digital contents. The portable device 220, which receives the new digital contents, reads the device information inserted into the contents before reproducing the contents, compares the device information with its own device information and determines whether the contents are to be reproduced. The portable device 220 may be implemented to reproduce the received digital contents only when its own device information is identical or substantially identical to the device information of the contents. Consequently, unauthorized reproduction of the digital contents is impossible even if another user of the portable device 220 tries to illegally copy the digital contents and to use them.

The digital contents are provided to the network device 230 from the contents providing server 210 in the same way or in a substantially similar manner as the manner in which the digital contents are provided the portable device 220.

When a user tries to reproduce digital contents in the portable device 220, the user usually downloads the digital contents to the network device 230 such as a PC and then downloads them from the network device 230 to the portable device 220. In this case, the network device 230 serves as a server that provides the digital contents. The portable device 220 receives the digital contents from the network device 230, inserts its own device information and then stores the digital contents in a memory. The digital contents stored in the portable device 220 can then still not be reproduced because they were illegally copied to the network device 230.

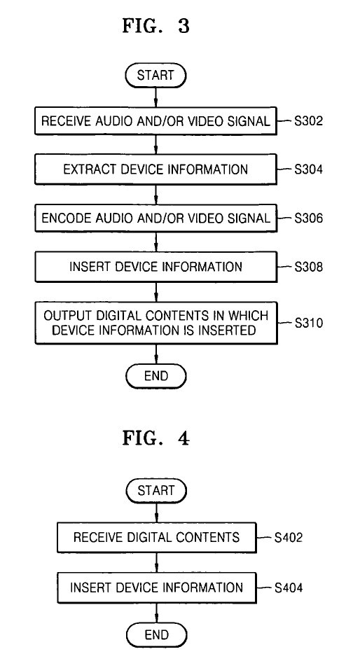

FIG. 3 is a flowchart illustrating a method of producing digital contents according to an embodiment of the present invention. Firstly, an operation of obtaining digital data needs to be performed. The acquisition of the digital data is performed by obtaining digital data from an arbitrary source or receiving and encoding an audio/video (A/V) signal from an external A/V signal source. FIG. 3 illustrates the latter case. Referring to FIG. 3, first, the A/V signal is received from the external audio/and video signal source in operation S302. Identity information of a user device granted with an authority to reproduce the digital contents is extracted in operation S304. The received audio and/video signal is encoded in a predetermined format and transformed into digital data in operation S306. The device information is inserted in the digital data in operation S308 and digital contents produced are output in S310. The digital contents generated using this process may be generated in one of the digital contents file formats illustrated in FIGS. 1A through 1C or, of course, in other formats.

By inserting the device information into the digital data, the digital contents are produced as digital data that is already encoded in the predetermined format. As in FIG. 3, here, the obtained digital data may be in one of the digital contents file formats illustrated in FIGS. 1A through 1C or, of course, in other formats. That is, the device information may be recorded in one or more areas among the header area 30, the data area 40, and the added information area 50 illustrated in FIGS. 1B and 1C. According to the file format of the digital data, in order to insert the device information into encoded digital data, first, the digital data needs to be again decoded. In this case, when the decoded digital data is encoded again, the device information is inserted into the digital data.

Even in the embodiment of FIG. 3, there are some encoding methods, in which the device information needs to be inserted into the encoded digital data when encoding the audio and/video signal. In this case, operations S306 and S308 are simultaneously performed.

FIG. 4 is a flowchart illustrating a method of downloading digital contents according to another embodiment of the present invention. Referring to FIG. 4, the digital contents are received from a server in operation S402, device information is inserted into the received digital contents in operation S404 and new digital contents are produced. As is described above, while the digital contents are being encoded again in a predetermined format after the digital contents are decoded, the device information may be inserted into the encoded digital data.

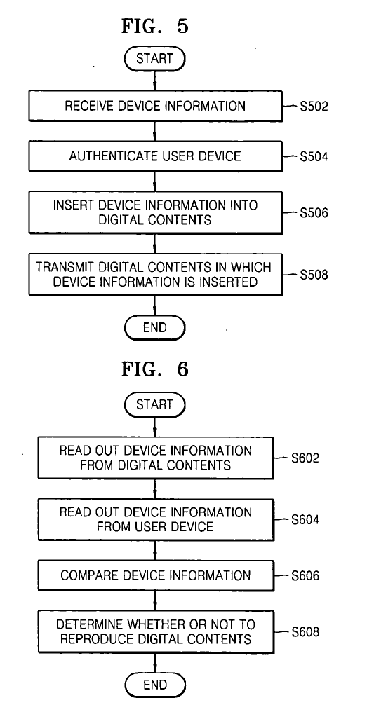

FIG. 5 is a flowchart illustrating a method of providing digital contents according to another embodiment of the present invention. If device information is received from a user device by a server in operation S502, the received device information is sent to an authentication server and the user device is authenticated in operation S504. If the user device is determined to be authorized, the device information is inserted into digital contents which the user device requests in operation S506 and the newly produced digital contents are transmitted to the user device in operation S508. Even at this time, while the digital contents are being encoded again in a predetermined format after the digital contents are decoded, the device information may be inserted into the encoded digital data.

FIG. 6 is a flowchart illustrating a method of reproducing digital contents according to another embodiment of the present invention. FIG. 6 illustrates a process where produced or provided digital contents are reproduced in a user device using the method illustrated in FIG. 5. As shown in FIG. 6, first, device information is read from the digital contents in operation S602. Thereafter, device information of the user device itself is read in operation S604 and is compared with device information, which is read from the digital contents, in operation S606. According to the comparison result, whether the user device is authorized to allow the digital contents to be reproduced is determined in operation S608. For example, the digital contents are allowed to be reproduced only when device information of the digital contents is identical to the device information of the user device. Therefore, the digital contents cannot be reproduced in an unauthorized device, in which device information of the digital contents is not identical to the device information of the user device.

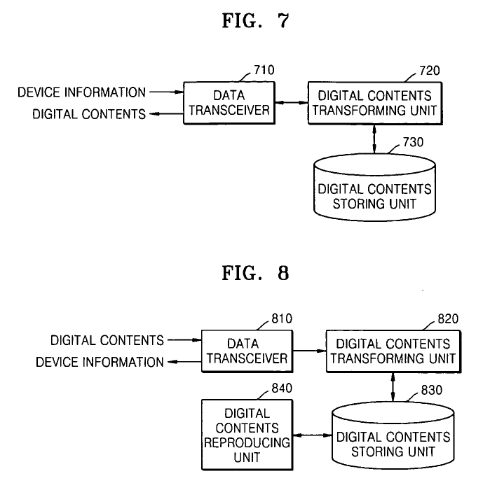

FIG. 7 illustrates a structure of a digital contents providing server according to an embodiment of the present invention. As shown in FIG. 7, the digital contents providing server includes a digital contents storing unit 730 to store digital contents for a contents provision service, a data transceiver 710 to provide for communications with external devices, and a digital contents transforming unit 720 to produce the digital contents transmitted to a client that requests the digital contents.

The digital contents providing server re-encodes the requested digital contents in a predetermined format to provide the digital contents. That is, the digital contents transforming unit 720 obtains the digital contents requested from the digital contents storing unit 730, inserts device information received from the client into the obtained digital contents, produces new digital contents to be transmitted to the client and transmits them through the data transceiver 710.

FIG. 8 illustrates a structure of a system of reproducing digital contents according to an embodiment of the present invention. As shown in FIG. 8, the system includes a digital contents storing unit 830 to store the digital contents, and a digital contents reproducing unit 840 to obtain and reproduce the digital contents to be reproduced from the digital contents storing unit 830. The digital contents reproducing unit 840 determines whether the digital contents are to be reproduced before reproducing the digital contents read from the digital contents storing unit 830. That is, the digital contents reproducing unit 840 itself determines whether the digital contents reproducing unit 840 is authorized to reproduce the digital contents. The digital contents reproducing unit 840 compares device information, inserted into the digital contents, that is to be reproduced, with its own device information. The digital contents reproducing unit 840 then determines whether to reproduce the digital contents based on this comparison. For example, the digital contents reproducing unit 840 reproduces the digital contents only when the device information inserted into the digital contents is identical to its own device information.

Moreover, when the system of reproducing digital contents receives a digital contents providing service from an external server, the system further includes a data transceiver 810 receiving the digital contents through a network, and a digital contents transforming unit 820 to produce data in which its own device information is inserted into the received digital contents and storing the data in the digital contents storing unit 830. In this way, the digital contents in which device information is inserted and which are re-encoded cannot be reproduced without authorization in another reproducing device. Alternatively, the reproduction system transmits the device information to the external server through the data transceiver 810 when requesting the digital contents from the external server. The external server uses the device information for authenticating the reproduction system and/or producing new digital contents that only the reproduction system can use.

In accordance with aspects of the present invention, the methods and systems discussed above may be embodied as computer readable codes recorded on a computer readable recording medium to execute the methods and systems.

As is described above, in an information storage medium in which digital contents are recorded according to aspects of the present invention, and the method and system for managing digital contents according to aspects of the present invention, the use of the digital contents is fundamentally prevented in an unauthorized user device, and consequently, counterfeiting of the digital contents is prevented.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An information storing medium in which digital contents are recorded, wherein the digital contents comprise device information to identify a user device and digital data, the device information being used to determine a state of a usage authorization of the digital contents.

2. The information storing medium according to claim 1, wherein the user device is a device to reproduce the digital contents.

3. An information storing medium in which digital contents are recorded, the information storing medium comprising:
a data area in which audio and/or video data is stored;
a header area in which header information about the audio and/or video data is stored; and
an added information area in which additional information about the audio and/or video data is stored, wherein device information to identify a user device is recorded in at least one of the data area, the header area, and the added information area, the device information being used to determine a state of a usage authorization of the digital contents.

4. The information storing medium according to claim 3, wherein the user device is a device that reproduces the digital contents.

5. A method of producing digital contents, the method comprising:
obtaining digital data; and
inserting device information to identify a user device into the obtained digital data that is authorized to produce the digital contents.

6. The method according to claim 5, wherein the obtaining of the digital data comprises:
receiving an audio and/or video signal from an audio and/or video signal source; and
encoding the audio and/or video signal in a predetermined format to transform the audio and/or video signal into the digital data.

7. The method according to claim 6, wherein the encoding of the audio and/or video signal into the digital data further comprises producing the obtained digital data including a data area in which audio and/or video data is stored, a header area in which header information about the audio and/or video data is stored, and an added information area in which additional information about the audio and/or video data is stored; and wherein the inserting of the device information comprises inserting the device information into at least one of the data area, the header area, and the added information area.

8. The method according to claim 6, wherein the inserting of the device information comprises:
extracting the identity information of a device that reproduces the digital data; and
inserting the extracted identity information into the digital data.

9. The method according to claim 5, wherein the obtained digital data comprises a data area in which audio and/or video data is stored, a header area in which header information about the audio and/or video data is stored, and an added information area in which additional information about the audio and/or video data is stored, and wherein the inserting of the device information comprises inserting the device information into at least one of the data area, the header area, and the added information area.

10. The method according to claim 5, wherein the inserting of the device information comprises:
decoding the obtained digital data; and
encoding the decoded data in a predetermined format and inserting the device information.

11. The method according to claim 5, wherein the obtaining of the digital data comprises downloading the digital data from a remote server.

12. The method according to claim 11, wherein the inserting of the device information comprises:
decoding the obtained digital data; and
encoding the decoded data in a predetermined format and inserting the device information.

13. A computer readable medium having a program stored thereon to execute the method according to claim 5.

14. A method of producing digital contents, comprising:
receiving an audio and/or video signal from an audio and/or video signal source;
extracting device information to identify a user device; and
encoding the audio and/or video signal in a predetermined format and inserting the device information into the formatted audio and/or video signal.

15. A computer readable medium having a program stored thereon to execute the method according to claim 14.

16. A method of providing digital contents, the method comprising:
receiving device information to identify a user device;
inserting the received device information into the digital contents to be provided; and
transmitting the digital contents into which the device information is inserted.

17. The method according to claim 16, further comprising:
authenticating the user device in accordance with the received device information; and
determining whether the digital contents are to be provided.

18. The method according to claim 17, wherein the inserting of the device information comprises:
decoding the digital contents to be provided; and
encoding the decoded data in a predetermined format and inserting the device information into the formatted decoded data.

19. A method of reproducing digital contents, the method comprising:
reading device information included in the digital contents;
reading device information from a user device that is to reproduce the digital contents;
comparing the device information of the digital contents with the device information of the user device; and
determining whether the digital contents are to be reproduced according to the comparison result.

20. A computer readable medium having a program stored thereon to execute the method according to claim 19.

21. The method according to claim 20, wherein the determining comprises determining to reproduce the digital contents if the device information of the digital contents is identical to the device information of the user device.

22. A server providing digital contents, the server comprising:
a digital contents storing unit to store the digital contents;
a data transceiver to receive a digital contents request, the digital contents request including device information to identify a user device and to transmit the requested digital contents to a client requesting the digital contents; and
a digital contents transforming unit to obtain the requested digital contents from the digital contents storing unit, to insert the transmitted device information into the obtained digital contents to produce digital contents to be transmitted to the client, and to output the digital contents to the data transceiver.

23. A system to reproduce digital contents, the system comprising:
a digital contents storing unit to store the digital contents; and
a digital contents reproducing unit to obtain the digital contents to be reproduced from the digital contents storing unit, to compare device information inserted in the obtained digital contents with its own device information, and to determine whether the obtained digital contents are to be reproduced.

24. The system according to claim 23, further comprising:
a data transceiver to receive the digital contents via a network; and
a digital contents transforming unit to insert its own device information into the received digital contents, and to store the digital contents in the digital contents storing unit.
